(19) United States
(12) Patent Application Publication
(10) Pub. No.: US 2008/0115087 A1
(43) Pub. Date: May 15, 2008

(54) TRACKING RECENT CONTACTS

(75) Inventors: Kelly E. Rollin, Seattle, WA (US); Jose Furia, Seattle, WA (US); Eran Shtiegman, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/559,342

(22) Filed: Nov. 13, 2006

(51) Int. Cl. G06F 3/048; G06F 17/30

(52) U.S. Cl. 715/811; 707/100; 707/E17.005

(57) ABSTRACT

A method and system for tracking recent real-time conversation participants, or contacts, of a user is provided. The real-time communication system receives an indication of a conversation between a user and a conversation participant and adds the conversation participant to a list of the user's recent contacts. The real-time communication system displays the list of recent contacts to the user to select from when the user initiates a real-time conversation.

### BACKGROUND

Users of computing devices (e.g., laptops, cellular phones, and personal digital assistants) often need to communicate in real time. A common form of real-time communication is provided by instant messaging services. An instant messaging service allows participants at endpoints to send messages and have them received within a second or two by the other participants in a conversation. The receiving participants can then send responsive messages to the other participants in a similar manner. To be effective, a real-time conversation relies on the participants' becoming aware of, reviewing, and responding to received messages very quickly. This quick response is in contrast to conventional electronic mail systems in which the recipients of electronic mail messages respond to messages at their convenience.

When an initiating participant wants to start a real-time conversation, that participant needs to know whether the intended participants are available to respond in real time to a message. If not, then communication via conventional electronic mail, voice mail, or some other mechanism may be more appropriate. For example, if the computers of the intended participants are currently powered off, then a real-time conversation may not be possible. Moreover, if their computers are currently powered on, but the intended participants are away from their computers, a real-time conversation is also not possible. The initiating participant would like to know the availability of the intended participants so that an appropriate decision on the form of communication can be made.

Presence services provide this availability information. The availability status of an entity such as a computer system or a user associated with that computer system is referred to as “presence information.” Presence information identifies the current “presence state” of the user. Users make their presence information available to a presence service so that other users can decide how best to communicate with them. For example, the presence information may indicate whether a user is logged on (“online”) with an instant messaging server or is logged off (“offline”). Presence information may also provide more-detailed information about the availability of the user. For example, even though a user is online, that user may be away from their computer in a meeting. In such a case, the presence state may indicate “online” and “in a meeting.”

Presence services may also store a buddy list for each user of the presence service that stores a list of participants with whom the user shares a close relationship, such as family, coworkers, and friends. Some real-time communication systems allow communications to be received from participants that are not in a user's buddy list. For example, a user may receive a telephone call from a conversation participant that the user does not know through a telephone device coupled with real-time communication software running on the user's computer system. If the user wants to have a subsequent conversation with the conversation participant, the user may not know the conversation participant's contact information. Even when a user wants to have a subsequent conversation with a conversation participant in the user's buddy list, the user may still have difficulty finding contact information for the desired conversation participant. For example, the user's buddy list may be so large that it is difficult for the user to find the desired conversation participant without sifting through hundreds of buddy list members. The user may also have many buddy list members with similar names, such as those having a last name of Smith, making it difficult for the user to quickly find a conversation participant with whom the user communicated earlier.

### SUMMARY

A method and system for tracking recent real-time conversation participants, or contacts, of a user is provided. The real-time communication system receives an indication of a conversation between a user and a conversation participant and adds the conversation participant to a list of the user's recent contacts. The real-time communication system displays the list of recent contacts to the user to select from when the user initiates a real-time conversation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the system, in one embodiment.

FIG. 2 is a system diagram that illustrates several modes of communication handled by the real-time communication system, in one embodiment.

FIG. 3 illustrates a display page of the user interface of the real-time communication system, in one embodiment.

FIG. 4 is a flow diagram that illustrates the processing of an update list component of the system, in one embodiment.

FIG. 5 is a flow diagram that illustrates the processing of the list display component, in one embodiment.

FIG. 6 is a table illustrating data contained by the recent contacts list, in one embodiment.

### DETAILED DESCRIPTION

A method and system for tracking recent real-time conversation participants, or contacts, of a user is provided. The real-time communication system receives an indication of a conversation between a user and a conversation participant. For example, the conversation participant may have initiated an instant messaging conversation with the user, and the real-time communication system is notified at the start of the conversation. Then, the real-time communication system adds the conversation participant to a list of the user's recent contacts. The real-time communication system maintains the contact information (e.g., email address, phone number, etc.) for conversation participants. Before adding a conversation participant to the list of recent contacts, the real-time communication system may determine whether the conversation participant is already on the list by having recently participated in a conversation with the user. For example, the user and conversation participant may have had an instant messaging conversation earlier in the day. The real-time communication system may display the list of recent contacts to the user the next time the user initiates a real-time conversation. The list of recent contacts may also be always displayed. In this way, the user is able to easily find contacts with whom the user has recently communicated, regardless of whether the contacts are members of the user's buddy list.

In some embodiments, the real-time communication system tracks recent contacts that have participated in a conversation with the user through any of multiple modes of communication. For example, a real-time communication system may allow a user to communicate with conversation participants through instant messaging, voice over IP (VoIP), video chat, audio chat, or other mode of communication. The real-time communication system maintains a list of conversation participants with whom the user has communicated through any of these modes of communication. The user can then easily find the conversation participant for subsequent communications regardless of the mode of communication used for the original communication. The real-time communication system may also store an indication of the mode of communication used for previous communications with other information about the recent contact. This allows the user, for example, to contact the conversation participant through the same mode of communication in the future.

In some embodiments, the real-time communication system receives an indication of both incoming and outgoing communications. A conversation between a user and a receiving participant can be initiated in many ways. For example, the conversation participant may send an instant message to the user, or the user may send an instant message to the conversation participant. Similarly, the user may call the conversation participant using voice over IP, or the conversation participant may initiate a video chat with the user. Regardless of how the initial conversation was initiated, the real-time communication system identifies the conversation participant and adds the conversation participant to the list of recent contacts. Although outgoing communications are usually to a conversation participant that the user already knows (e.g., a contact in the user's buddy list), incoming communications may be from an unknown user for which the user does not already have contact information. By tracking incoming communications, the real-time communication system allows the user to initiate subsequent real-time communications with conversation participants that would otherwise be difficult to contact.

In some embodiments, the real-time communication system limits the recent contacts list to a certain number of contacts. For example, the recent contacts list may be limited to a predetermined number of contacts (e.g., 10). The real-time communication system may also use a first-in, first-out (FIFO) or other similar algorithm to remove contacts from the recent contacts list to maintain the number of contacts below the limit. For example, if the recent contacts list is limited to 10 contacts, then when an 11^{th} contact is added to the list, the first contact may be removed from the list to make room for the 11^{th} contact. The real-time communication system may determine the contact limit dynamically, such as by observing how many conversation participants the user has in a certain period of time, or may also allow the user to configure the limit.

In some embodiments, the real-time communication system may track the frequency with which each conversation participant is contacted. For example, the real-time communication system may increment a count each time a conversation occurs between the user and each conversation participant. The real-time communication system can use this information to prevent a contact that is contacted very frequently from being removed from the recent contacts list. For example, if several new conversation participants with whom the user has only had one conversation are added to the recent contacts list, a previous member of the list may need to be removed. However, if the member to be removed is a frequent contact, then it may be more desirable to remove the oldest, less frequently contacted list member. The real-time communication system uses the stored frequency of contact information to make this kind of determination.

In some embodiments, the real-time communication system may limit the number of conversation participants added in a single conversation. Many conversations consist of multiple participants. For example, the real-time communication system may support conference calls between many conversation participants at a time. The user may not know all of the conversation participants or want all of the conversation participants added to the recent contacts list. In addition, the list may be limited in size as discussed above, and the user may not want the current list members to be removed by a single call having more participants than the list size. Therefore, the real-time communication system may only add a limited number of conversation participants to the recent contacts list, or may not add any conversation participant from a multiple participant conversation to the recent contacts list. Alternatively, the real-time communication system may add all conversation participants to the list, regardless of the size of the conversation.

In some embodiments, the real-time communication system may determine whether a conversation participant can be contacted in the future before adding the conversation participant to the list. For example, the user may receive a call from a conversation participant for which the real-time communication system cannot obtain the calling number. A user cannot subsequently contact such a conversation participant anyway, so the real-time communication may not add the conversation participant to the recent contacts list. Similarly, the user may make a call to a conversation participant through a desk phone, without using the real-time communication system, in such a way that the real-time communication system cannot determine the number that the user called. Here, too, the real-time communication system avoids adding the conversation participant to the recent contacts list because the conversation participant cannot be contacted in the future due to the lack of contact information known by the real-time conversation system.

In some embodiments, the real-time communication system sorts the recent contacts list before the list is displayed to the user. For example, the list may be sorted according to the time each conversation participant was added to the list, or by the time of the last contact with each conversation participant. Alternatively, the list may be sorted using other information such as the online status of each conversation participant. For example, the user may want to see online contacts higher in the list than offline contacts. Alternatively, the list may be sorted alphabetically or based on other attributes of the conversation participants.

In some embodiments, the real-time communication system dynamically determines attributes of users to sort the list of recent contacts based on. For example, the real-time communication system may dynamically build a group of users currently using a particular application, such as a development environment or a word processing application. The real-time communication system can sort the list of recent contacts based on this attribute. This may allow the user to find coworkers working on the same type of work, or allow a technical support representative to determine which users are using a help application and may need additional technical support.

In some embodiments, the real-time communication system is implemented as an add-on component to existing real-time communication software. For example, the real-time communication software may provide an event application programming interface (API) through which the add-on component can register an event handler to be notified of new conversations and the conversation participants. The add-on component may also provide a recent contacts list by using an API that allows the add-on component to modify the user interface of the real-time communication software. Alternatively, the add-on component may provide a separate user interface for displaying information about recent contacts.

In some embodiments, the real-time communication system transfers users from the recent contacts list to a user's buddy list. For example, a user may request that a frequent contact on the recent contacts list be added to the user's buddy list. The system may also automatically determine that a frequent contact should be added to the user's buddy list based on frequency of contact, relationship with other conversation participants on the user's buddy list, or other criteria.

The real-time communication system will now be described with reference to figures illustrating some embodiments of the functionality described above.

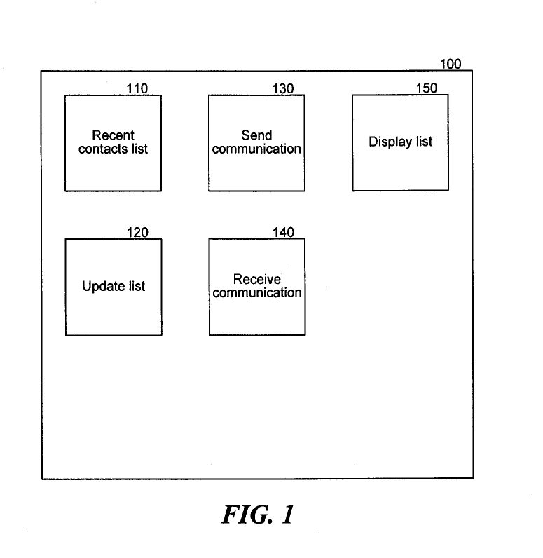

FIG. 1 is a block diagram that illustrates components of the system in one embodiment. The real-time communication system 100 contains a recent contacts list 110, an update list component 120, a send communication component 130, a receive communication component 140, and a display list component 150. The recent contacts list 110 stores the list of conversation participants with whom the user has recently had a conversation. The update list component 120 updates the recent contacts list 110 upon the occurrence of an event that affects the list. For example, when a new communication is received, the update list component 120 identifies the conversation participant and adds the conversation participant's information to the recent contacts list 110. The send communication component 130 monitors sent communications to determine when the user is initiating a conversation with a conversation participant. The receive communication component 140 monitors received conversations to determine when the user has received a new conversation invitation from a conversation participant. Either sending or receiving new communications may lead to a new recent contact being added to the recent contacts list 110. The display list component 150 displays the recent contacts list in a user interface.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

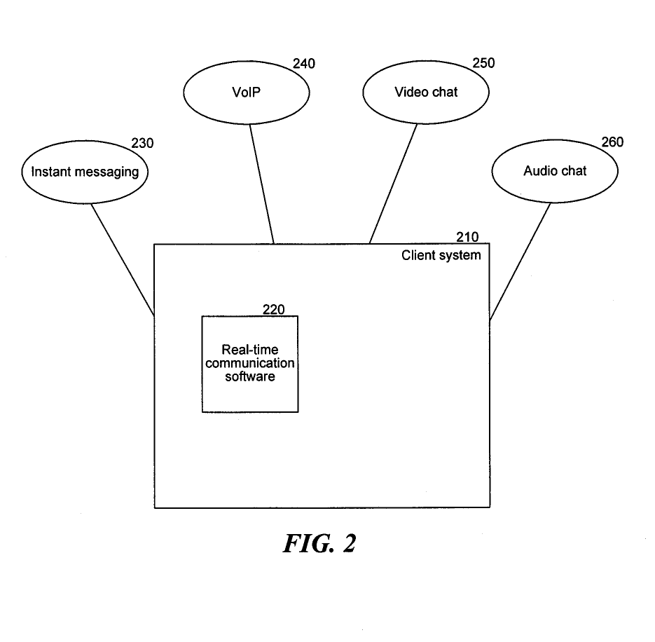

FIG. 2 is a system diagram that illustrates several modes of communication handled by the real-time communication system, in one embodiment. A client system 210 contains real-time communication software 220. The real-time communication software 220 allows the user of the client system 210 to communicate using modes of communication such as instant messaging 230, VoIP 240, video chat 250, and audio chat 260. The real-time communication software 220 may support additional modes of communication, such as a telephone device coupled to the client system 210 for placing calls using a traditional telephone line.

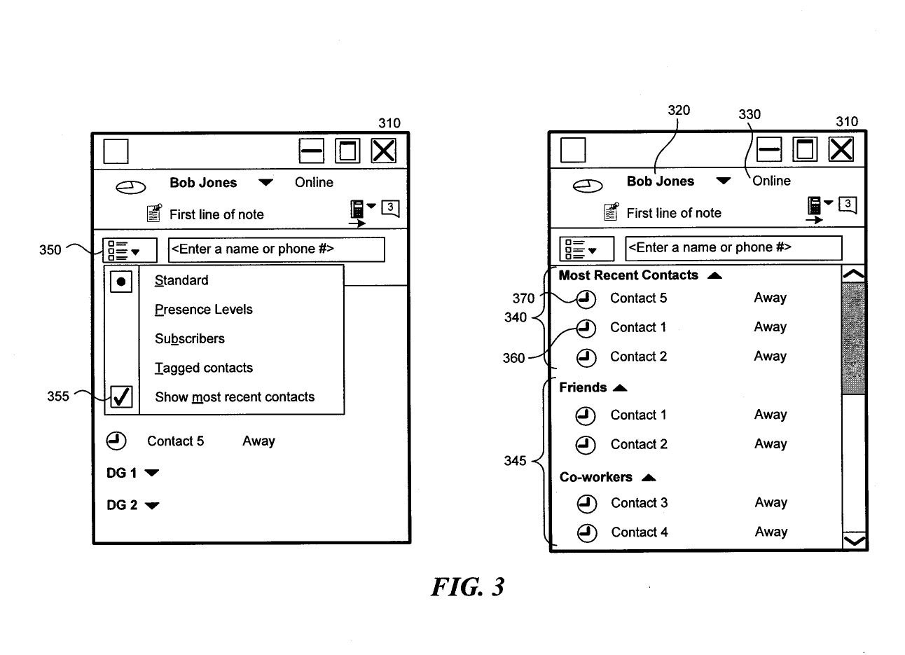

FIG. 3 illustrates a display page of the user interface of the real-time communication system, in one embodiment. The display page contains a real-time communication user interface window 310. The user interface window 310 contains an identification of the user 320, the user's online status 330, the user's recent contacts list 340, and the user's buddy list 345. The user interface window 310 may provide a user configuration button 350 for displaying user configuration options such as an option 355 to show or hide the most recent contacts list 340. The most recent contacts list 340 may contain conversation participants that are also in the user's buddy list 345, such as Contact 1 360. The recent contacts list 340 may also contain conversation participants that are not in the user's buddy list 345, such as Contact 5 370.

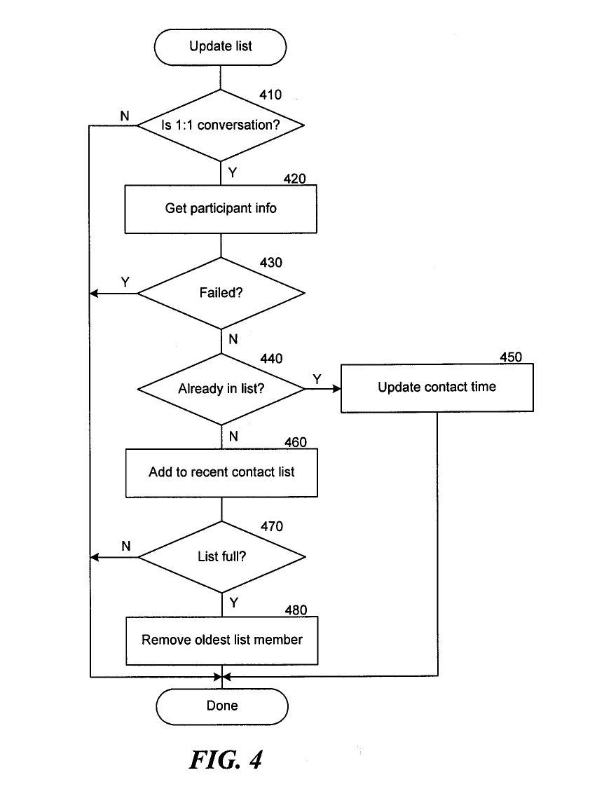

FIG. 4 is a flow diagram that illustrates the processing of the list update component of the system in one embodiment. The component is invoked when a new conversation is initiated by the user or an invitation to a new conversation is received by the user. In decision block 410, if the conversation is a one-on-one conversation, then the component continues at block 420, else the component completes. A one-on-one conversation is a conversation in which there are only two participants, as opposed to a conference call or other multiple participant conversation. In block 420, the component retrieves information about the conversation participant, such as the participant's contact information, user identifier, or other information. In decision block 430, if the component fails to retrieve contact information for the conversation participant, then the component completes, else the component continues at block 440. In decision block 440, if the conversation participant is already a member of the recent contacts list, then the component continues at block 450, else the component continues at block 460. In block 450, the component updates the last contact time for the conversation participant stored in the recent contacts list. In block 460, the component adds the conversation participant to the list of recent contacts. In decision block 470, if adding the new recent contact made the list full (e.g., adding the 11^{th} contact if the list is limited to 10 contacts), then the component continues at block 480, else the component completes. In block 480, the component removes the oldest member from the recent contacts list. The component then completes.

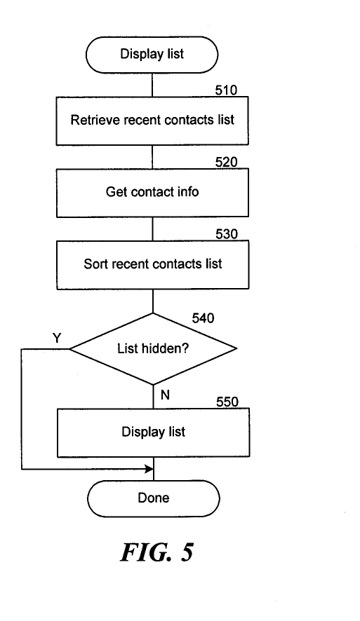

FIG. 5 is a flow diagram that illustrates the processing of the list display component, in one embodiment. The component is invoked when the user interface displays the most recent contacts list. In block 510, the component retrieves the recent contacts list. The real-time communication system may store the recent contacts list on a server or client. For example, the recent contacts list may be stored in the registry of a client computer system of the user. Alternatively, the recent contacts list may be stored on a server, such as a presence server, accessible by multiple client computing systems of the user. In block 520, the component retrieves information for each conversation participant that is a member of the recent contacts list. In block 530, the component sorts the recent contacts list. For example, the component may sort the list based on the time of the last communication with each conversation participant, or by each conversation participant's online status. In decision block 540, if the recent contacts list has been hidden in the user interface, then the component completes, else the component continues at block 550. In block 550, the component displays the recent contacts list. The component then completes.

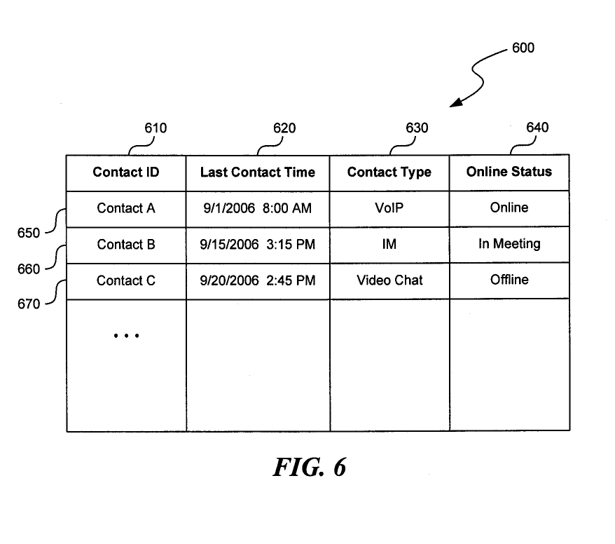

FIG. 6 is a table illustrating data contained by the recent contacts list, in one embodiment. The table 600 contains a contact identifier column 610, a last contact time column 620, a contact type column 630, and an online status column 640. The contact identifier column 610 contains the display name and contact information for the contact. The last contact time column 620 identifies the time that the user last had a conversation with the contact. The contact type column 630 stores the mode of communication used for the last conversation between the user and the contact. The online status column 640 specifies the current online status of the contact. Several sample entries are shown in the table 600. For example, the first entry 650 contains a contact with an identifier “Contact A” that last contacted the user on Sep. 1, 2006, at 8:00 A.M, using VoIP as the mode of communication, and with a current status of “online.” A second entry 660 contains a recent contact “Contact B” that used instant messaging to communicate with the user and is currently in a meeting. A third entry 670 contains a recent contact “Contact C” that used video chat to communicate with the user and is currently offline.

From the foregoing, it will be appreciated that specific embodiments of the real-time communication system have been described herein for purposes of illustration, but that various modifications may be made without deviating from the spirit and scope of the invention. For example, although real-time communication has been described in conjunction with the invention, other modes of communication, such as email, are also compatible with the teachings herein. Accordingly, the invention is not limited except as by the appended claims.

I/We claim:

1. A method in a computer system for tracking recent contacts of a user, comprising:
receiving an indication of a real-time conversation between a conversation participant and the user through any of multiple modes of communication;
adding the conversation participant to a list of recent contacts; and
displaying the list of recent contacts to the user.

2. The method of claim 1 further comprising, if the recipient has had another recent conversation with the user, updating a time of last contact in the list of recent contacts.

3. The method of claim 1 wherein the conversation participant is not a member of a buddy list of the user.

4. The method of claim 1 wherein the received indication is an indication of an incoming invitation to join a conversation.

5. The method of claim 1 wherein the received indication is an indication of an outgoing request to initiate a conversation.

6. The method of claim 1 wherein the list of recent contacts is limited to a predetermined number of entries.

7. The method of claim 1 further comprising, before adding the conversation participant, if adding the conversation participant would cause the list to contain more than a predetermined number of entries, deleting the oldest entry.

8. The method of claim 1 further comprising, before adding the conversation participant, if adding the conversation participant would cause the list to contain more than a predetermined number of entries, deleting an entry based on the frequency of communication with the conversation participant specified by the entry.

9. The method of claim 1 wherein adding comprises determining whether the conversation participant has had another recent conversation with the user, and when the conversation participant has not had another recent conversation with the user, adding the conversation participant to the list of recent contacts.

10. A computer-readable medium encoded with computer-executable instructions for controlling a computer system to identify a participant for a conversation with a user, by a method comprising:
creating a list of recent contacts configured to contain participants to which communications have been recently sent and participants from which communications have been recently received
when a communication is sent by the user to a participant, adding the participant to the list of recent contacts;
when a communication is received by the user from a participant, adding the participant to the list of recent contacts;
displaying the list of recent contacts to the user;
receiving a selection from the user of a participant from the list of recent contacts; and
initiating a conversation with the selected participant.

11. The computer-readable medium of claim 10 further comprising sorting the list of recent contacts by a last contact time stored for each recent contact before displaying the list of recent contacts to the user.

12. The computer-readable medium of claim 10 further comprising determining an online status for each recent contact and sorting the list of recent contacts based on the determined online status for each contact before displaying the list of recent contacts to the user.

13. The computer-readable medium of claim 10 further comprising sorting the list of recent contacts alphabetically by a display name for each recent contact before displaying the list of recent contacts to the user.

14. A computer system for maintaining a data store of recent contacts for a user, comprising:
a recent contacts data store that identifies contacts who have had recent communications with the user;
a contacts updating component that updates the recent contacts data store when a notification of a communication with a new contact is received;
a communication receiving component that notifies the contacts updating component when a communication is received; and
a communication sending component that notifies the contacts updating component when a communication is sent.

15. The system of claim 14 wherein a communication is received when a conversation participant sends the user an invitation to join a conversation.

16. The system of claim 14 wherein a communication is sent when the user initiates a conversation with a conversation participant.

17. The system of claim 14 wherein the contacts updating component determines whether a new contact can be reached before adding the new contact to the recent contacts data store.

18. The system of claim 14 wherein the contacts updating component removes an old contact from the recent contacts data store if adding a new contact would cause the recent contacts data store to contain more than a threshold number of entries.

19. The system of claim 14 wherein the contacts updating component stores supplemental information about new contacts in the recent contacts data store.

20. The system of claim 19 wherein the supplemental information comprises a time of a last conversation between the new contact and the user.
